(19) United States
(12) Patent Application Publication
(10) Pub. No.: US 2005/0173905 A1
(43) Pub. Date: Aug. 11, 2005

(54) Ignition device for a pyrotechnic system in a motor vehicle

(75) Inventors: Franz Wier, Goeggingen (DE); Karl-Heinz Koeppel, Schwaebisch-gmuend (DE)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: TRW Automotive GmbH

(21) Appl. No.: 11/051,911

(22) Filed: Feb. 4, 2005

(30) Foreign Application Priority Data
Feb. 5, 2004 (DE) 10 2004 005 687.0

(51) Int. Cl. B60R 21/26

(52) U.S. Cl. 280/736

(57) ABSTRACT

An ignition device for a pyrotechnic system in a motor vehicle includes an igniter and an interface unit (20) for the production of an electrical connection of the ignition device with a release system. The interface unit (20) is held in a housing (10) of the pyrotechnic system in a form-fitting manner without a further mounting.

### BACKGROUND OF THE INVENTION

The invention relates to an ignition device for a pyrotechnic system in a motor vehicle.

Pyrotechnic systems are used in motor vehicle safety devices, e.g. in belt tensioner systems, in pyrotechnically activated belt systems or in airbag systems. In particular, belt tensioner systems with a small gas generator are known, which is arranged at one end of a tensioner housing, in which in turn a piston is held displaceably as an actuating part. The ignition device of the gas generator serves to ignite a propellant charge, the expansion of the thus generated gas being used to drive the piston which is coupled to a safety belt. The electrical connection of the ignition device is generally realized by an interface unit. The interface unit usually is an injection-molded plastic component held in a mounting. The mounting, usually a turned part produced by machining, and the interface unit, are joined together to form an assembly unit before the assembly of the gas generator and before the gas generator is installed into the housing.

It is an object of the invention to provide an ignition device for a pyrotechnic system, which requires less structural space, can be produced at a more favourable price and requires less effort in assembly.

### BRIEF SUMMARY OF THE INVENTION

The ignition device according to the invention comprises an igniter and an interface unit for the production of an electrical connection of the ignition device with a trigger system, the interface unit being held in a housing of the pyrotechnic system in a form-fitting manner without a further mounting. The invention is based on the finding that a mounting for the interface unit can be dispensed with when the interface unit itself is held in the housing in a form-fitting manner. The retainer used hitherto and the interface unit “melt” to form a single component which can have smaller dimensions. On assembly of the gas generator, the joining of the interface unit and the mounting to form an assembly unit is eliminated, which simplifies the production of the ignition device and makes it more favourably priced.

The interface unit is preferably an injection-molded plastic component. In the manufacture of the interface unit, the geometry for the electrical connections is molded onto a part (corresponding to the mounting used hitherto) which is adapted to the geometry of the housing. The single-piece interface unit has an increased mechanical stability compared with an assembly composed of a mounting and an interface unit, in particular with respect to pressure forces.

Moreover, the interface unit can be constructed in one piece with a holding part made of plastic, which holds a mounting for the igniter. Thus, the structure of the ignition device can be designed so as to be even simpler and more compact.

The interface unit can also be constructed in one piece with the housing. This increases the inherent strength of the housing, because the notch effect (stress concentration) on the contact surface formed between housing and mounting is completely eliminated.

A further significant structural space reduction is enabled in that the interface unit is constructed in one piece with a mounting for the igniter. The external geometry of this unit can be freely established accordingly depending on the manufacturing method which is applied.

A single-piece construction of the interface unit with a protective casing, the protective casing surrounding an ignition means arranged inside the housing and being able to be activated by the igniter, provides for a distinctly reduced assembly effort compared with a construction with individual parts.

### BRIEF DESCRIPTION OF THE DRAWINGS

FIG. 1 shows a lateral sectional view of an ignition device in accordance with a first embodiment of the invention;

FIG. 1a shows a variant of the first embodiment;

FIG. 2 shows a lateral sectional view of an ignition device in accordance with a second embodiment of the invention;

FIG. 3 shows a lateral sectional view of an ignition device in accordance with a third embodiment of the invention; and

FIG. 4 shows a lateral sectional view of an ignition device in accordance with a fourth embodiment of the invention.

### DETAILED DESCRIPTION OF THE INVENTION

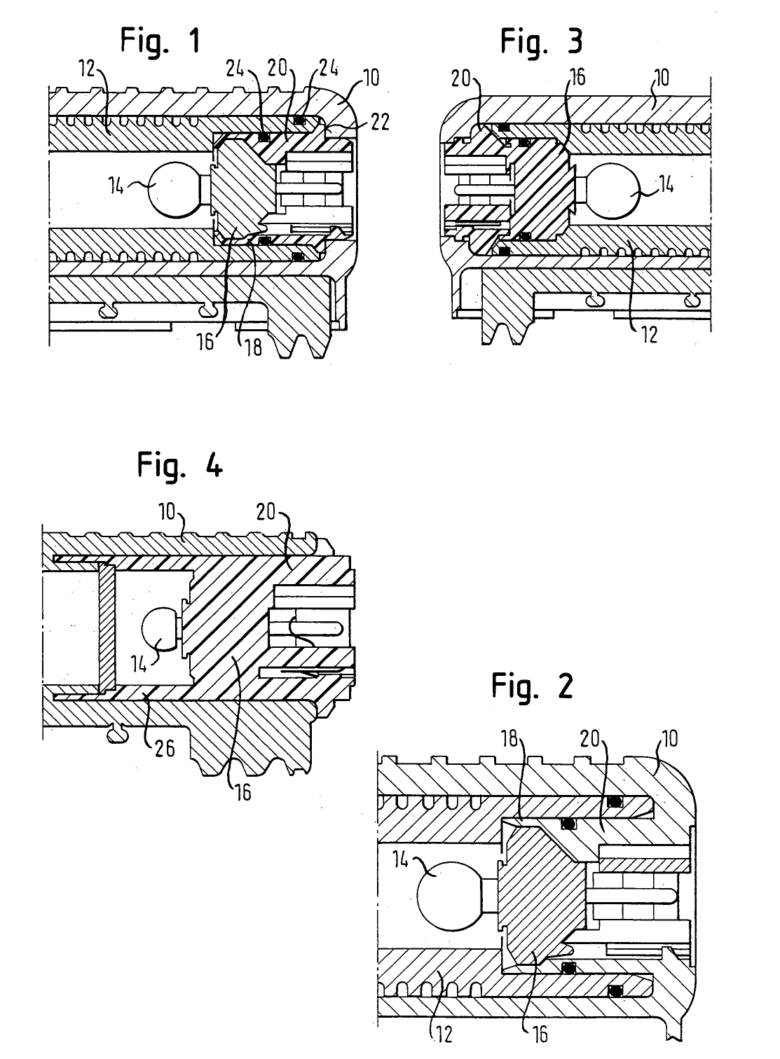

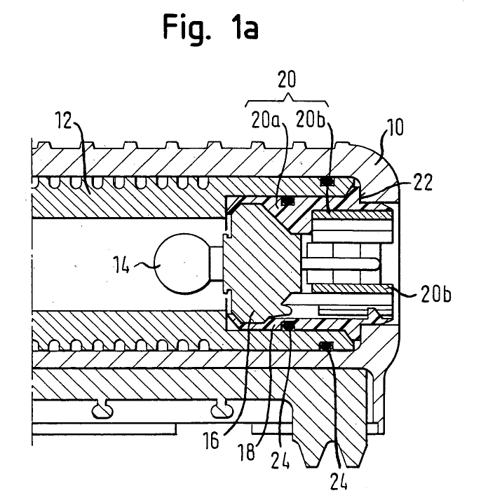

In FIG. 1 a first embodiment of an ignition device for a belt tensioner according to the invention is illustrated. In a tensioner housing 10, a piston 12, coupled to a safety belt (not shown), is held displaceably. At an open end of the housing 10, the ignition device is inserted. The ignition device comprises an ignition means 14 in the form of a so-called ignition pill (primer) which is activated by an igniter. The igniter is housed in a mounting 16 which, in turn, is held by a holding part 18. An interface unit 20 for the electrical connection of the ignition device to a trigger system is constructed in one piece with the holding piece 18. The interface unit 20, including the holding part 18, is an injection-molded plastic component and is shaped so that it rests directly on the housing 10, in particular on a ring-shaped end surface 22 of the housing 10, without a further mounting. The form-fitting mounting of the interface unit 20 ensures a secure rest of the ignition device in the housing 10. A sealing between the housing 10 and the piston 12 and also between the piston 12 and the unit comprising the holding part 18 and the interface unit 20 is achieved by O-rings 24.

The variant shown in FIG. 1a differs from the embodiment according to FIG. 1 only in that not the entire geometry of the interface unit 20 is constructed in one piece with the holding part 18, but rather only the part designated by 20a. In order to complete the geometry of the interface unit 20, a simplified component 20b is additionally used.

In the embodiment shown in FIG. 2, compared with the embodiment previously described, the holding part 18 together with the interface unit 20 is constructed in one piece with the tensioner housing 10. The edge of the housing 10 is guided inwards and continues directly into the interface unit 20. The geometry for the electrical connections of the interface unit 20 can be molded on subsequently.

FIG. 3 shows an embodiment in which the interface unit 20 is constructed in one piece with the mounting 16 for the igniter. Here, also, all integrated parts are produced from plastic in an injection molding process.

In FIG. 4 an embodiment is shown with a protective casing 26 for the ignition means 14, which together with the igniter mounting 16 and the interface unit 20 is constructed as an integrated injection-molded plastic component.

Of course, the features described in the individual embodiments can also be combined with each other.

The invention was described by means of the example of a belt tensioner, but is not restricted to this use. The ignition device according to the invention can be used in all pyrotechnic systems, in which a gas generator or the like is inserted into a housing.

1. An ignition device for a pyrotechnic system in a motor vehicle, the injection device comprising an igniter and an interface unit (20) for the production of an electrical connection of the ignition device with a trigger system, characterized in that the interface unit (20) is held in a housing (10) of the pyrotechnic system in a form-fitting manner without a further mounting.

2. The ignition device according to claim 1, characterized in that the interface unit (20) is an injection-molded plastic component.

3. The ignition device according to claim 1, characterized in that the interface unit (20) is constructed in one piece with a holding part (18) made of plastic, which holds a mounting (16) for the igniter.

4. The ignition device according to claim 3, characterized in that the entire geometry of the interface unit (20) is constructed in one piece with the holding part (18).

5. The ignition device according to claim 3, characterized in that only a part (20a) of the geometry of the interface unit (20) is constructed in one piece with the holding part (18), and an additional component (20b) completes the geometry of the interface unit (20).

6. The ignition device according to claim 1, characterized in that the interface unit (20) is constructed in one piece with the housing (10).

7. The ignition device according to claim 6, characterized in that the interface unit is formed on an edge of the housing (10) projecting into the interior of the housing (10).

8. The ignition device according to claim 1, characterized in that the interface unit (20) is constructed in one piece with a mounting (16) for the igniter.

9. The ignition device according to claim 1, characterized in that the interface unit (20) is constructed in one piece with a protective casing (26), the protective casing (26) surrounding an ignition means (14) arranged inside the housing (10) and being able to be activated by the igniter.
